(19) United States
(12) Patent Application Publication
(10) Pub. No.: US 2005/0000459 A1
(43) Pub. Date: Jan. 6, 2005

(54) Bird feed packaging with instant feeders

(76) Inventors: Steven N. Buhl, Albuquerque, NM (US); Aneta G. Buhl, Albuquerque, NM (US)

Correspondence Address: Steven N. Buhl, 6004 Stoney Bluff Ct NW, Albuquerque, NM, 87120, US

(21) Appl. No.: 10/873,582

(22) Filed: Jun. 22, 2004

Related U.S. Application Data
(60) Provisional application No. 60/482,031, filed on Jun. 24, 2003.

(51) Int. Cl. A01K 61/02

(52) U.S. Cl. 119/52.2

(57) ABSTRACT

This invention is packaging of bird feed as instant bird feeders, comprising seed reservoirs filled by bird seed processors, conveniently operable packaging for the consumer, and bird feeder components including feed trough, perches and means to collect waste hulls and discarded seeds.

### CROSS REFERENCE TO RELATED APPLICATION

This application claims the benefit of U.S. Provisional Application No. 60/482,031, filed Jun. 24, 2003 the disclosure of which is hereby incorporated by reference herein and made a part hereof, including but not limited to those portions which specifically appear hereinafter.

### STATEMENT REGARDING FEDERALLY SPONSOERED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to instant/disposable bird feeders featuring convenience of use, ease of manufacture and security in retail.

There is a plethora of bird feeders and of art and inventions but none addresses all the needs of the end-user consumer, retail packaging, bird feed manufacturer and bird feeder manufacturer. For example, some unmet needs of typical end-user consumers—particularly apartment dwellers—include avoiding the mess of filling bird feeders from bulk bags of bird seed; avoiding the mess from seed hulls and bird rejected seeds during feeding, avoiding maintenance and cleaning issues of the bird feeder. Retailers require efficient packaging of products to reduce required shelf space, and reduction of the number of products, particularly those with voids and those that are none stackable, and with increasingly more secure and robust packaging. Bird feed manufacturers have needs for new products that cater to the needs of consumers, are easy to manufacture while providing incremental income without undue factory updates: The bird feeder manufacturers require products with lower numbers of parts that can be manufactured efficiently.

In general, see for example, U.S. Pat. Nos. 6,581,540-B1, 5,634,429, 5,269,242, 4,738,221, 4,077,361, 6,390,021, 5,634,429, 4,989,548, 4,570,575, 4,706,851 which relate to bird feeders. One such bird feeder is disclosed in U.S. Pat. No. 6,581,540-B1. In this patent, bird feed is conveniently package and meets the needs of bird feed manufacturers; some of the retailers' needs for convenient product configuration, and less of the needs of the consumer. Once the feed container is placed in the feeder, it is extremely difficult to remove the cap, the feeder requires regular maintenance and cleaning. Another such bird feeder is disclosed in U.S. Pat. No. 4,738,221, in this patent of an instant bird feeder, the molded plastic parts require more complicated molding tools having pull-outs, require the end-user to break-off plastic parts and to assemble the feeder before use, and does not include a tray to catch the discarded hulls and rejected seeds that fall to the floor or ground during use. Still another such bird feeder is disclosed in U.S. Pat. No. 4,077,361, this invention is complicated to manufacture by having a container with inside and outer walls and the bird feed is meant to be filled by the end-use consumer.

### BRIEF SUMMARY OF THE INVENTION

It is an object of this invention to provide instant bird feeders that are convenient to put into use and reduce the mess that invariably is associated with feeding wild birds. It is another object of this invention to provide manufacturers of bird feed a variety of packaging and instant bird feeder options to present to their customers.

The above and other objects of this invention are accomplished by use of closure systems that are integrated into various bird feed packaging to provide secure packaging, are easy to put into use operation, and have means to capture the hulls and debris generated during feeding. Preferably, the feeding system includes a seed reservoir containing seeds filled by a bird feed manufacturer, packaging that the end-user can access easily, closures that comprise feeder elements such as that the end-user can easily manipulate to put the feeder into use, seed ports that meter the feed flowing into feed troughs, perches for the birds, and a tray or bag to capture the seed hulls and seeds discarded by the birds during feeding. After the feed is consumed, the feeder and mess from the feeding activity are disposed. The parts of the container and closure are easy to manufacture and are a minimal number to reduce cost.

In one preferred embodiment, the closure system is incorporated into packages of various sizes of feed and of various materials such as soft plastic bags or rigid molded/formed containers. To put into use the end-user simply hangs the feeder, removes a tear tab and twists the closure to match the feed ports in the feed package and the closure. The closure system comprises a feed trough, perches and may include means for waste collection and shield against the elements of snow and rain and unwanted diners.

In another preferred embodiment the closure system is included into packages of various sizes of feed and of various materials such as soft plastic bags or rigid molded/formed containers. To put into use the end-user simply lifts the feeder from its box, and hangs the feeder. The closure telescopically opens and feed flows into the feed trough. The closure system comprises a feed trough, perches and may include means for waste collection and shield against the elements of snow and rain and unwanted diners.

In still another preferred embodiment the closure system is incorporated into packages of various sizes of feed and of various materials such as soft plastic bags or rigid molded/formed containers. To put into use the end-user simply hangs the feeder, removes a tear tab used to seal the substantially matched feed ports in the feed package and the closure. The closure system comprises a feed trough, perches and may include means for waste collection and shield against the elements of snow and rain and unwanted diners.

Configurations for perches generally fall into four major categories, (a) perches with dimensions fixed by the manufacturer, (b) self spreading upon putting the feeder in to use, (c) mechanically effected spreading when the feeder is put into use (d) and manually effected extension when the feeder is put into use.

Although many variations can be contemplated, in another preferred embodiment the perches are “spring like” in nature so as to compress during packing and while in storage or retail. In another preferred embodiment the perches are retracted during shipping and storage and readily extended by a simple motion of the end-user consumer.

In another preferred embodiment the waste collection container is a bag that is adhered, annealed or otherwise attached to the perches. In another preferred embodiment the waste collection container is a rigid tray that is incorporated as part of the closure system so as to reduce the number of parts needing manufacture.

Features from the above preferred embodiments can be intermixed to create any number of packaging configurations so that the optimal production costs and end-user convenience can be achieved in additional preferred embodiments.

### BRIEF DESCRIPTION OF THE SEVERAL VIEWS OF THE DRAWINGS

Preferred embodiments of the invention are illustrated in the accompanying drawings in which reference numerals represent like parts throughout and in which

FIG. 1 illustrates the compactness of the shipping and retail unit of the embodiment having inherent spring perches.

FIG. 2 illustrates the in-use feeder from FIG. 1.

FIG. 3 illustrates the three pieces and preferred features of invention in FIG. 1

FIG. 4 illustrates alternate embodiments of closures

FIG. 5 illustrates alternate embodiments of closures

FIG. 6 illustrates alternate embodiment of closure

FIG. 7 illustrates the compactness of the shipping and retail unit of the embodiment utilizing a flexible bag.

FIG. 8 illustrates the end-user putting the invention into use.

FIG. 9 illustrates the in-use feeder from FIG. 7.

FIG. 10 illustrates the cross section view of the parts from the system in FIG. 9.

FIG. 11 illustrates the telescoping lid/feeder with feed port in the lid/feeder

FIG. 12 illustrates the hook version of the stop ribs.

FIG. 13 illustrates the rotate-and-project the perches from the lid/feeder, perches retracted.

FIG. 14 illustrates the rotate-and-project the perches from the lid/feeder, perches projected.

### DETAILED DESCRIPTION OF THE INVENTION

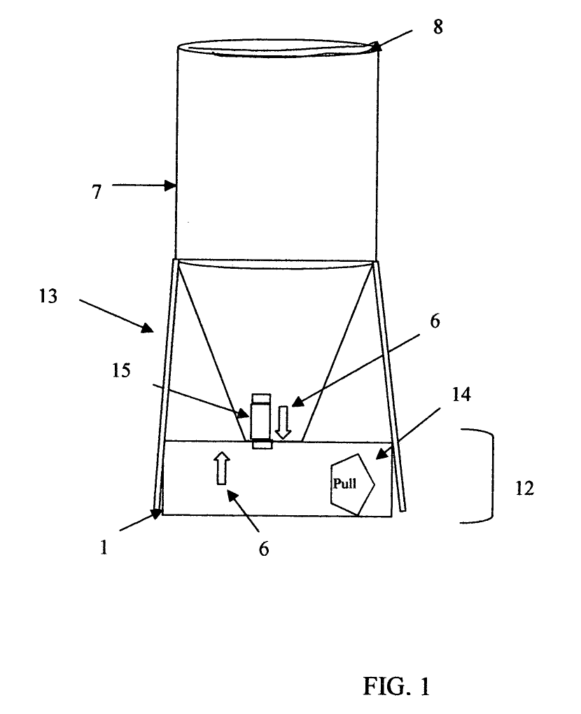

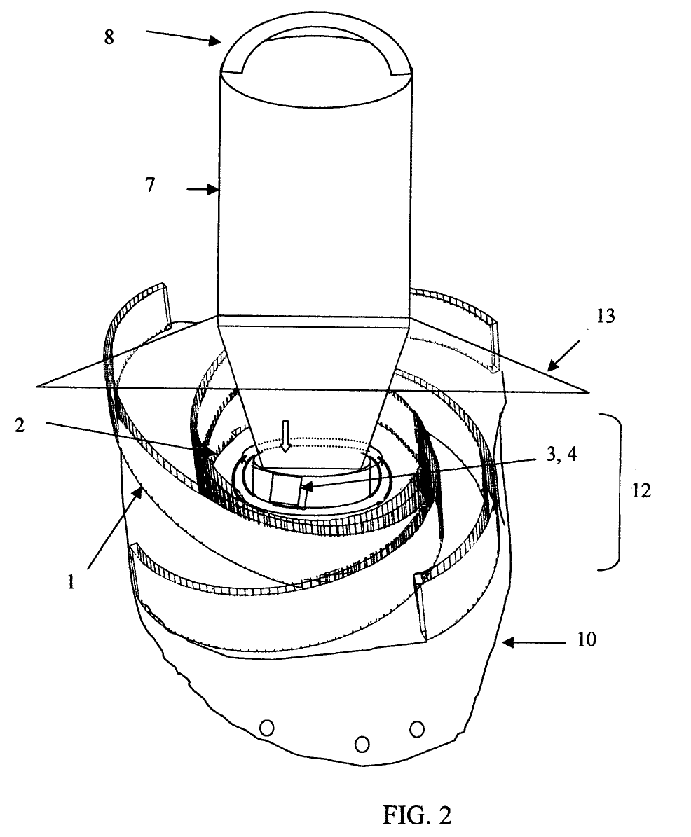

Referring to FIG. 1, the preferred embodiment of the invention in its shipping/retail packaging (FIG. 1) is shrink-wrapped. Now referring to FIGS. 1-3, to put into operation, the shrink wrap is removed thereby releasing the hanger (8), a waste collection bag (10), and compressed skirt/canopy (13) and providing access to the security tape (15) and the retaining band (14) that compresses the perches (1). The end-user hangs the feeder at the feeding location, removes the security tape (15), rotates the feed container (7) relative to the lid/feeder (12) to align either visually or through the use of indicator arrows (6) the feed ports (3,4) and pulls the retaining band (14) off to release the perches (1). The in-use configuration of the feeder is illustrated in FIG. 2.

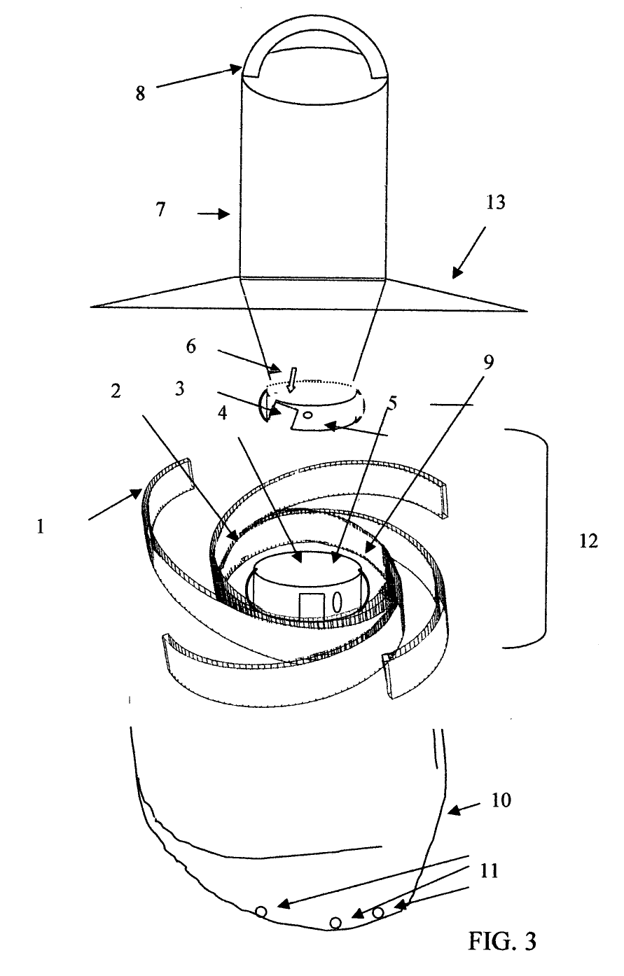

FIG. 3 illustrates the construction of the pieces within the invention of FIG. 1. The features of the container piece (7) include a hanger (8) a container that is sized to hold from about 0.5 to 5 pounds of bird feed (7) an indicator arrow (6) and a mating closure having feed ports (3), a skirt/canopy (13) and a mechanical stop (5). Preferably the feed container is rigid and contains up to about 5 pounds of bird feed. The single piece lid/feeder portion (12) consists of a securably fitting but rotatable mate to the container closure (9), and a concentric wall at a diameter about 1-2 inches larger than the lid portion of the closure system thereby providing a feed trough (2). The lid/feeder portion (12) also includes a feed port (4) and a stop (5) complementary to the feed port (3), stop (5) in the container piece (7), and perches (1) that expand when the retaining ring (14) is removed. Adhered, annealed or otherwise attached to the perches (1) is a bag (10) for collecting debris. Said bag is opened when the perches expand. Both the feed trough (2) and the waste collection bag (10) have weep holes (11). Although not illustrated, the lower portions of the perches can be elongated or extended to facilitate the use of a larger opening on the waste collection bag.

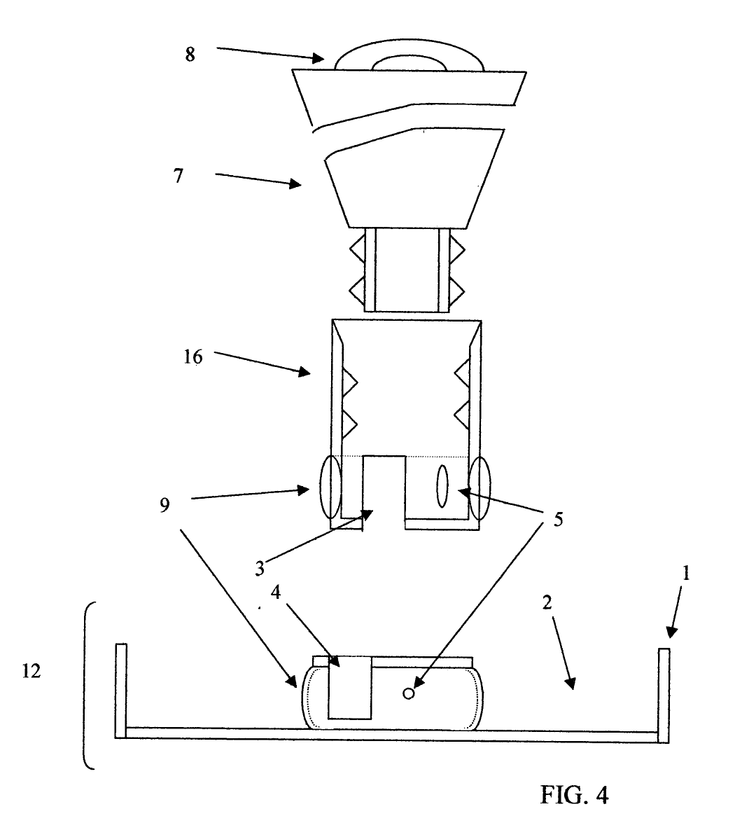

An alternate to including the feed port (3) in container (7) is to include the feed port(s) that communicate between the feed container (7) and the lid/feeder portion (12) into a separate closure mate (16). The closure mate interacts with the feed container and with the feeder portion to create securably fitting joints. Now referring to FIG. 4 and FIG. 5, said closure mates (16) with any screw (FIG. 4) or press fit (FIG. 5) containers (7) that the bird feed packager may currently use. Thereby providing additional advantage of not changing the container mold or former but creating a much smaller mold tool for the additional closure piece. For those skilled in the art of process development, they can readily determine the optimum choice between including the feed port in the container (7) or in a separate closure piece (16). In FIGS. 4 and 5, the rim of the feed trough (2) also functions as the perch (1). Alternately other perch configurations can be utilized and incorporated into the lid/feeder piece (12). A wide variety of containers can be used including those that are blow molded, thermoformed or spout bags such as those manufactured by Scholle Corporation, Chicago, Ill.

Although many securably fitting rotatable closures (threaded (FIG. 4) and non-threaded (FIG. 3 and FIG. 5)) are available, the preferred embodiment makes use of concentric toric shapes (9) that provide a snap fit between the lid/feeder (12) and feed container (7). In alternate embodiments, the container (7) has the external fitting mating closure (9) to the internally fitting closure on the lid/feeder portion (9) or the additional closure mate (16). For those skilled in the art, it is obvious that in the various parts the externally overlapping closures can be readily mated to internally fitting closures and vice versa as the situation requires to obtain secure fits, provide for ease of manufacture and end-user convenience.

Through the use of shoulder and neck configured sizes of the container (7) relative to the size of the feed trough (2), access to the bird feed can be restricted to certain bird sizes and protection from rain or snow can also be afforded the feed trough. For example, for finches the access height might be restricted to 1.5 inches whereas for cardinals, the access height might be restricted to 2.5 inches. Through the use of varying the length and spread of the perches, restrictions on the sizes of birds can be further imparted to the invention.

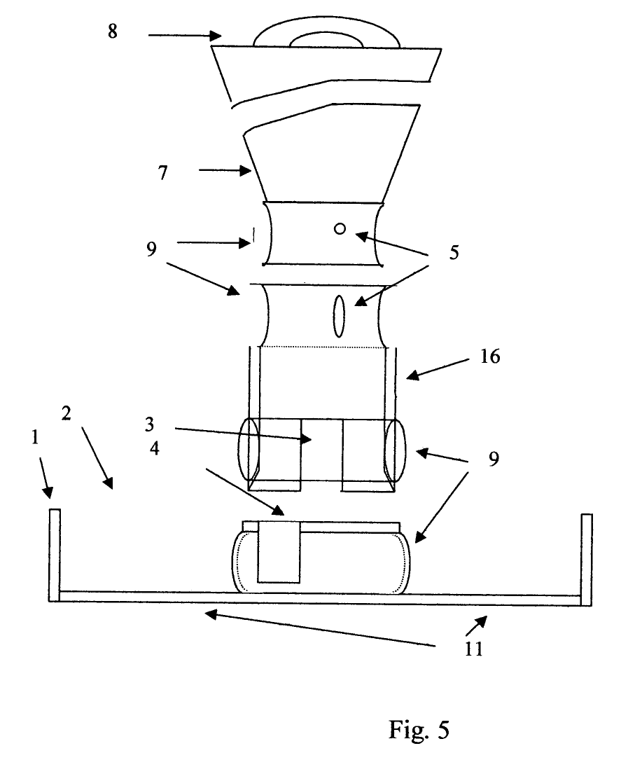

Still an additional embodiment of the invention uses a rotatable closure included in the lid/feeder portion (12) and that mates with the feed container (7) (FIG. 6). In said embodiment, the path of feed from the container is vertical through feed port (3) to the feed trough (2). If filling the feed container through feed port 3 and upon completion of the filling, lid/feeder part 12 can be applied by forcing the axle (18) through the hole (17) thereby sealing the container (7). Said operation of filling the feed and forcing the axle through the hole is best performed by a manufacturer. The flange on axle (18) prevents the axle from escaping the hole (17). Features such as indicator arrows (6), security tape (15), shrink wrapping can be added as desired and needed. To put into use the end-user removes any shrink wrap, security tape and such, rotates the lid/feeder assembly till feed port (3) permits feed to flow into feed trough (2) or if the mechanical stop (5) feature is included until the stop is engaged. The amount of feed in the feed trough is metered relative to the effective ratio of the height “h” to the height of the feed trough wall (1). Although it seems that with only ports that open less than one-half of the allowable opening and the feed is directed to only a portion of the feed trough, there would be an uneven level of feed in the feed trough; however, the small vibrations from the wind and from birds landing on and taking off from the feeder, the feed quickly becomes nearly even throughout the feed trough. The amount of feed is metered into the feed trough by the height “h” in FIG. 6 to remain below the height of the feeder trough wall (1) in FIG. 6.

The walls of the ring that forms the outer perimeter of the feed trough functions as the wall of the feed trough (2) and as the perch (1). Alternately, the spring perches (1) describe in FIG. 2 and FIG. 3 can be included, and still alternately, the waste collection bag (10) can also be incorporated.

Although the design of many mechanical stops are available, the preferred embodiment utilizes a bump of about 0.02 inches height and diameter on the container (7) and a depression in the lid portion of about 0.02 inches deep and up to about 0.3 inches long. In another preferred embodiment, no stop (5) was included and friction between securably fitting concentric rings (9) was relied upon.

The container optionally contains a skirt (13) of semi-ridged plastic formed using spring ribs and pleated or foldable webs that when attempts are made to access the feed trough from the top of the feeder, the weight of a mammal would deform the skirt and it would block access to the feed trough. The skirt would provide further protection from rain and snow. The skirt may be molded as part of the container or may be molded as a separate piece that slides onto the container and is held in place by friction.

Alternate embodiments include the use of more rigid waste collectors. An inverted umbrella style comprising ribs, a snap lock fitting and weep holes is contemplated. Another embodiment of the waste collection container is a Japanese lantern style that is folded/collapsed during shipping and retail, but expanded when in use (not illustrated). Variations in structures of the waste container are contemplated to provide aesthetic appeal to the feeder system.

Certain features such as the stop (5), the waste collection container (10) and the skirt (13) can be omitted and substitutions made such as using a flexible containers in the described embodiments without departing from the scope of the invention.

Various materials can be used in the manufacture of the components of the invention. The preferred material for the feed container is any of the more ridged plastics such as but not limited to polycarbonate, polypropylene, polyethylene, ABS or polyvinyl chloride, and of the very flexible plastics such as but not limited to polycarbonate, polypropylene, polyethylene, or polyvinyl chloride. Any of the said plastics or combinations of the said plastics and others can be used to make the waste collection container. The lid/perch system is preferentially made from any of the more ridged plastics. It is preferable to use plastics that can be recycled (HDPE, PPC, PETE, PET).

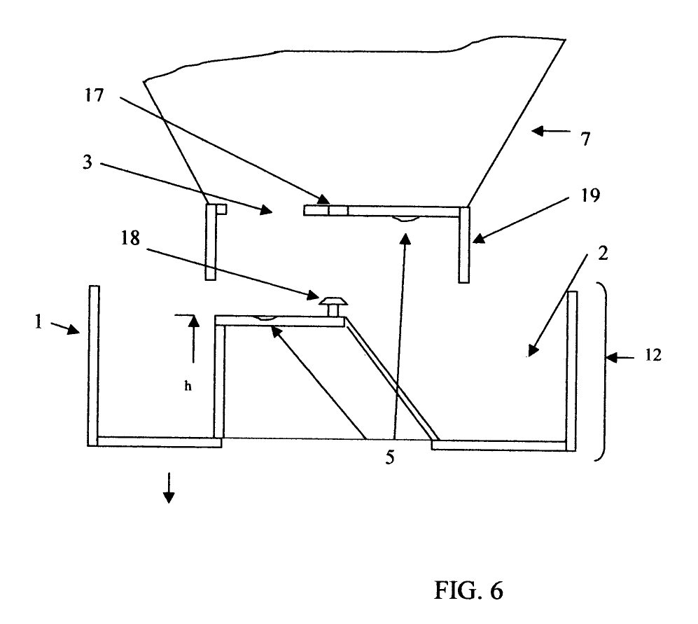

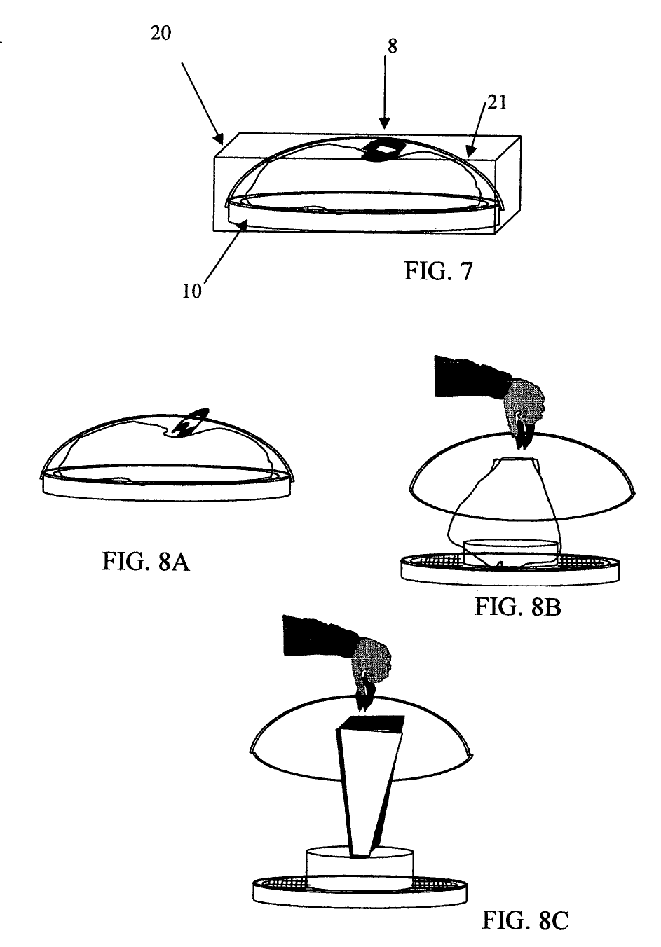

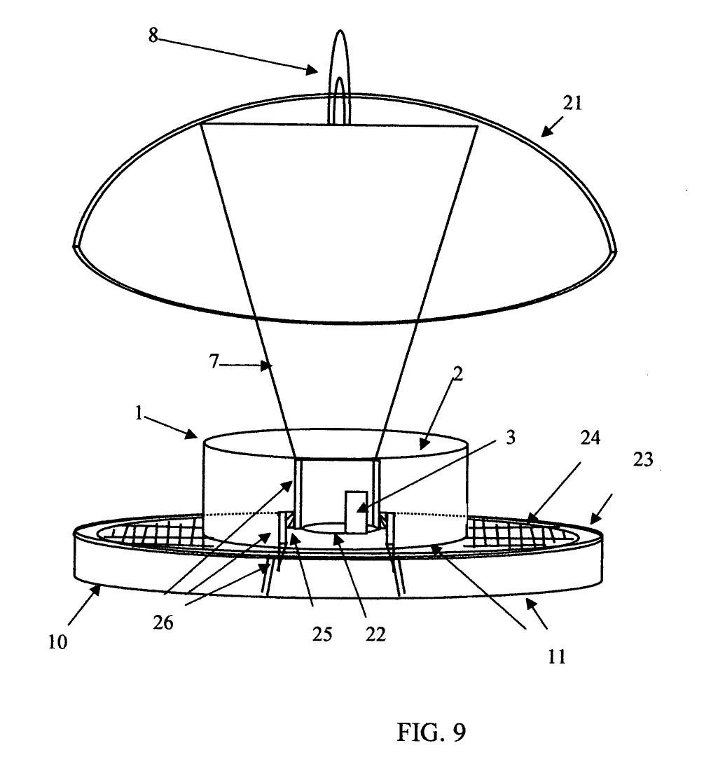

Referring to FIG. 7 and FIG. 8, the preferred embodiment of the invention in its shipping/retail packaging (FIG. 7) is in a box (20) and is put into operation by removing said invention from the box and lifting hanger (8) (FIG. 8A). The feeder “extends” to yield the in-use invention (FIG. 8C). The end-user hangs the feeder at the feeding location. FIG. 9 illustrates the construction of the pieces within the invention. Referring to FIG. 9, the features of the feed container piece (7) include a hanger (8) a container that is sized to hold from about 0.5 to 5 pounds of bird feed (7) and a telescoping closure (26) having one or more feed ports (3) a mechanical stop (25) and accepting a plug or foil (22). Preferably the feed container is flexible and contains up to about 5 pounds of bird feed.

Still referring to FIG. 9, the lid/feeder portion (12) of the closure system consists of a telescoping guide walls (26) and a mechanical stop mate (25) to the container stop mate (25), and a concentric wall at a diameter about 1-2 inches larger than the telescoping mate of the closure system thereby providing a feed trough (2). The said concentric wall may serve as the bird perch (1) although other structures may be added to be perches. In this preferred embodiment, the waste collecting container (10) is a rigid tray comprising the base of the telescoping lid/feeder portion (26) of the closure with weep holes (11), a perforated web (24) to allow seed hulls and other waste to enter the tray, an annular ring (23) surrounding the web to provide attachment to the tray through mechanical stops (25) and prevent waste escaping when the tray is tilted, and a tray (10) with weep holes (11) to contain the waste.

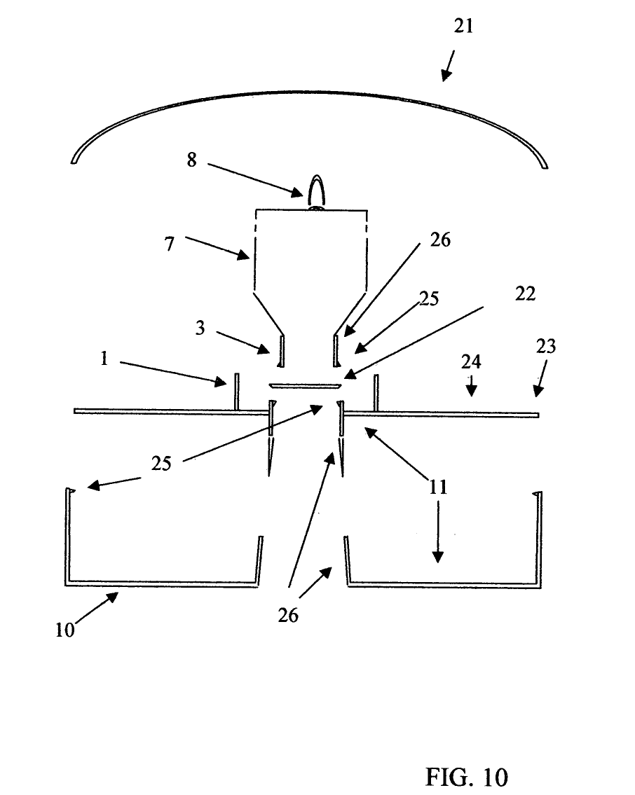

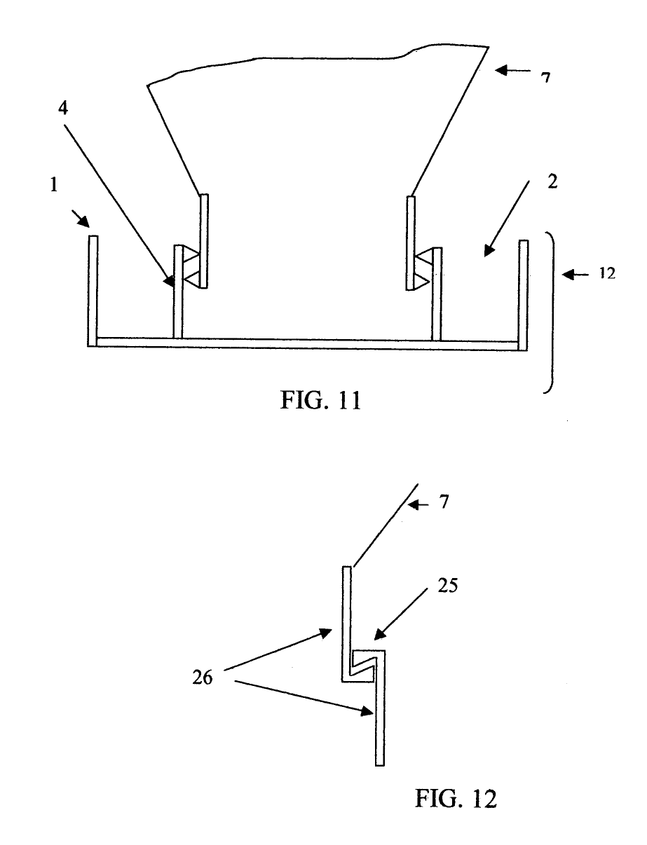

For those skilled in the art, FIG. 10 illustrates the five parts to manufacture to include all features in the preferred embodiment. Among the most simple embodiments of the invention, certain features may be substituted or omitted and still be within the scope of the invention. For example the canopy (21) may be omitted or directly incorporated in to the container during molding or forming. Additionally, the waste collecting tray (10) and its perforated web (24) may be omitted or substituted with one of the embodiments described elsewhere. Still further, the choice of the plug (22) can be a solid plug forced to fill the opening or a thermo-welded foiled plastic. Now referring to FIG. 11, in still another embodiment using the telescoping closure, the container is stopped when the telescope is collapsed. When extended, one or more feed ports (4) located in telescoping guide (25) of the lid/feeder portion (12) is opened. Although many securably fitting snap closures are available the preferred embodiment makes use of overlapping concentric ribs (25) that provide a snap fit between the feeder and feed container and the web ring and waste tray. To enhance the strength of the joints, the ribs may be molded to have hooks (FIG. 12).

Through the use of shoulder and neck configured sizes of the container relative to the size of the feed trough, access to the bird feed can be restricted to certain bird sizes and protection from rain or snow can also be afforded the feed trough. For example, for finches the access height might be restricted to 1.5 inches whereas for cardinals, the access height might be restricted to 2.5 inches.

Various materials can be used in the manufacture of the components of the invention. The preferred material for the feed container is any of the more ridged plastics such as but not limited to polycarbonate, polypropylene, polyethylene, ABS or polyvinyl chloride, and of the very flexible plastics such as but not limited to polycarbonate, polypropylene, polyethylene, or polyvinyl chloride. Any of the said plastics or combinations of the said plastics and others can be used to make the waste collection container. The lid/perch system is preferentially made from any of the more ridged plastics. It is preferable to use plastics that can be recycled (HDPE, PPC, PETE,PET).

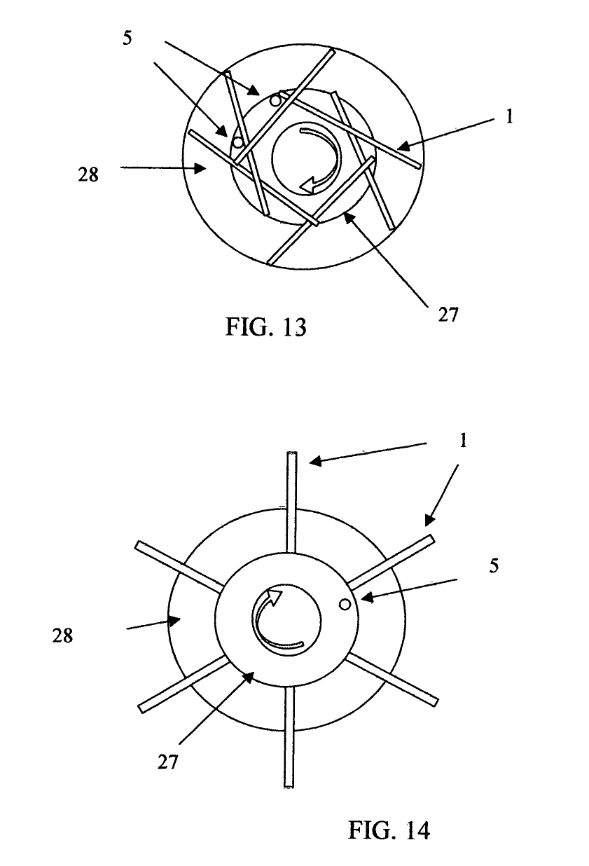

Although many configurations for perches that are convenient for the end-user may be contemplated, they generally fall into four major categories, perches with dimensions fixed by the manufacturer (FIG. 4 and FIG. 5), self spreading upon removal of packaging when putting the feeder in to use (FIG. 2), mechanically effected spreading when the feeder is put into use (FIG. 13 and FIG. 14), and manually effected spreading when the feeder is put into use.

Now referring to FIGS. 13 and 14, the perches are retracted during shipping to minimize packaging volume, reduce hazards by not having sharp points projecting while providing convenience (FIG. 13). Twisting the knob effects projection of the perches (FIG. 14). A flexible waste collecting container (10) can be annealed, adhered or otherwise secured to the extremities of the perches such as illustrated in FIG. 3. The knob on wheel (27) rotates on an axle of the construct shown in FIG. 6. Each of the perches (1) rotates about an axle on the perimeter of wheel (27) of the construct shown in FIG. 6 and projects through a hole in a perimeter or near perimeter ridge of the lid/feeder (28) which may comprise any of the closures described above. In still another embodiment of mechanically effected perches uses a fulcrum system such as in an umbrella (not shown). Preferentially this feeder includes the flexible bag waste collection system shown in FIG. 3 but another embodiment can include any number of variations of waste collection systems.

Also for those skilled in the art, it is obvious that in the various parts the externally overlapping closures can be readily mated to internally fitting closures in the container and vice versa as the situation requires to obtain secure fits, provide for ease of manufacture and end-user convenience.

Although the above descriptions and embodiments rely heavily on circular shapes, the same concepts can be applied to polygonal, elliptical and other geometric shapes without deviating from the invention.

While in the foregoing specification these inventions have been described in relation to certain preferred embodiments, and many details have been set forth, it will be apparent to those skilled in the art that variations in the embodiments and details described in the specifications and claims can be varied considerably without departing from the basic principles of the invention.

1. A bird feed packaging comprising a storage reservoir and
a lid/feeder means;
wherein, the storage reservoir is made from plastic and
said reservoir contains a closure mate that mates to a lid/feeder having means for providing a feed trough/perch and
said lid/feeder may be readily opened without disconnecting from said reservoir through vertical,
horizontal
or a combination of vertical and horizontal displacement to allow feed to flow from said reservoir to said feed trough.

2. A bird feed packaging comprising a storage reservoir and a lid/feeder means;
wherein, the storage reservoir is made from plastic, and
said reservoir contains a closure mate that mates to a lid/feeder having means for providing a feed trough/perch and
said lid/feeder has one or more ports aligned with ports on the reservoir wherein for shipping and storage purposes of the filled reservoir the ports are closed by means of a removable band or strip.

3. The systems of claim 1 and 2 where the lid/feeder includes a means for collecting waste hulls and seeds and mess from bird feeding activity.
Said means can be chosen from among a flexible bag, a rigid tray, or a combination thereof.

4. The systems of claim 1 and 2 where the lid/feeder comprises
bird perches such as structures of fixed dimension,
tractable from within to without of the lid/feeder,
manually effected extension when the feeder is put into use, or
springing from the lid/feeder upon removal of a restraint.
